(19) United States
(12) Patent Application Publication
(10) Pub. No.: US 2025/0378970 A1
(43) Pub. Date: Dec. 11, 2025

(54) MANUFACTURING METHOD OF THERMOPLASTIC POLYURETHANE COMPOSITE FOR X-RAY SHIELD REPAIR AND X-RAY SHIELD REPAIR METHOD

(71) Applicant: PUKYONG NATIONAL UNIVERSITY INDUSTRY-UNIVERSITY COOPERATION FOUNDATION, Busan (KR)

(72) Inventors: Junghwan KIM, Busan (KR); Seok Gyu KANG, Gimhae-si (KR); Dae Seong KWON, Gimhae-si (KR); Hyeon Kwang KIM, Busan (KR); Nazmul HOSSAIN, Busan (KR)

(73) Assignee: PUKYONG NATIONAL UNIVERSITY INDUSTRY-UNIVERSITY COOPERATION FOUNDATION, Busan (KR)

(21) Appl. No.: 19/232,320

(22) Filed: Jun. 9, 2025

(30) Foreign Application Priority Data
Jun. 10, 2024 (KR) 2024-0074847
Jun. 9, 2025 (KR) 2025-0074444

(51) Int. Cl. G21F 1/12; C08K 3/16

(52) U.S. Cl. CPC G21F 1/125; C08K 3/16; C08K 2201/011

(57) ABSTRACT

The present invention relates to a method for repairing a damaged portion of a radiation shielding material and provides a method for repairing the radiation shielding material by placing a polyurethane patch containing a bismuth halide compound on the damaged portion and melting the patch by applying heat.

### CROSS-REFERENCE TO RELATED APPLICATION

This application claims a benefit under 35 U.S.C. § 119(a) of Korean Patent Application No. 10-2024-0074847 filed on Jun. 10, 2024, and No. 10-2025-0074444 on Jun. 9, 2025, in the Korean Intellectual Property Office, the entire disclosure of which is incorporated herein by reference for all purposes.

### BACKGROUND

### 1. Field

The present invention relates to a method for repairing a radiation shielding material using a polyurethane patch containing a bismuth halide compound.

### 2. Description of Related Art

Specifically, the present invention provides a repair technique for restoring a damaged portion of a radiation shielding material, such as lead rubber used for shielding X-rays or gamma rays, which may become damaged during use. Without the need for complex equipment or adhesives, a polyurethane patch in which a bismuth halide compound is dispersed is placed over the damaged area and partially melted by applying heat, thereby filling the damaged portion and restoring the shielding performance.

### SUMMARY

The objective of the present invention is to provide a method for repairing a radiation shielding material using a polyurethane patch containing a bismuth halide compound.

The present invention provides a method for repairing a damaged portion of a radiation shielding material, the method comprising: placing a polyurethane patch containing a bismuth halide compound over the damaged portion of the radiation shielding material; and applying heat to the patch to melt it, thereby repairing the radiation shielding material using the polyurethane patch containing the bismuth halide compound.

In one embodiment, the radiation shielding material may include lead rubber.

Specifically, the present invention provides a repair technique for restoring a damaged portion of a radiation shielding material, such as lead rubber used for shielding X-rays or gamma rays, which may become damaged during use. Without the need for complex equipment or adhesives, a polyurethane patch in which a bismuth halide compound is dispersed is placed over the damaged area and partially melted by applying heat, thereby filling the damaged portion and restoring the shielding performance.

In one embodiment, the polyurethane patch may be prepared by mixing a bismuth halide compound, a polyurethane precursor, and an organic solvent.

In one embodiment, the bismuth halide compound may include bismuth iodide (BiI₃), and the polyurethane precursor may include hexamethylene diisocyanate (HDI), polyethylene glycol (PEG), and 1,4-butanediol (BDO).

In one embodiment, the polyurethane patch may be characterized in that the bismuth iodide (BiI₃) is dispersed within the polyurethane by forming coordination bonds between bismuth ions and nitrogen atoms in the polyurethane.

The polyurethane patch containing a bismuth halide compound according to the present invention can be prepared by uniformly dispersing the bismuth halide compound (BiI₃) during the polyurethane synthesis reaction, in which polyurethane is formed from precursors such as HDI, PEG, and BDO, by adding the bismuth halide compound during the reaction process.

This manufacturing method does not simply involve mixing polyurethane with BiI₃, but rather introduces BiI₃ together with the polyurethane precursors during the polyurethane synthesis process. In doing so, bismuth forms coordination bonds—specifically, electron pair sharing—between bismuth ions and nitrogen atoms within the urethane bonds of the polyurethane. This interaction suppresses the aggregation of BiI₃ and promotes its uniform dispersion throughout the polyurethane.

In particular, BiI₃ contains high atomic number elements (Bi and I), making it a functional inorganic material capable of effectively absorbing X-rays. When these particles are uniformly distributed throughout the polyurethane, high X-ray shielding performance can be achieved even with a small amount. The resulting polyurethane patch exhibits excellent mechanical flexibility and thermal adhesion, and can be applied to various substrates such as polyethylene, polypropylene, fabric, and glass.

In one embodiment, the organic solvent may include dimethylformamide (DMF), and by increasing the amount of DMF, a thin film-type polyurethane patch may be produced.

Before being mixed with the polyurethane precursors (HDI, PEG, BDO), BiI₃ may be uniformly dispersed using DMF as an organic solvent. The resulting BiI₃/DMF solution is then mixed with the polyurethane precursors, poured into a mold, and cured to form a patch. By increasing the amount of DMF from the conventional 2.5 mL to 12 mL, it is possible to produce a large-area, thin-film patch. Specifically, a patch having a thickness of approximately 0.14 mm and a size of 10×17 cm can be fabricated.

Accordingly, the polyurethane patch according to the present invention can be fabricated as a thinner and larger-area thin film by adjusting the amount of solvent. The resulting thin-film patch retains its flexibility and mechanical strength, enabling expanded applicability to medical protective garments, large-area shielding sheets, and wearable shielding materials.

In one embodiment, the melting may include melting the polyurethane patch by applying heat of 200° C. or higher, and the melted polyurethane patch may flow into the damaged portion of the radiation shielding material, thereby repairing the radiation shielding material.

In one embodiment, the radiation shielding material repaired using the polyurethane patch may exhibit a shielding rate of 90% or higher when subjected to a tube voltage of 60 kV.

In the present invention, a polyurethane patch containing a dispersed bismuth halide compound was directly placed on the damaged portion of the radiation shielding material, and a thermal transfer process was performed by rubbing the patch using a standard household iron set to the “Cotton” mode at approximately 200° C. When heat is applied, the thermoplastic polyurethane patch melts and becomes flowable, filling the gaps in the damaged area and adhering closely to the shielding material. Upon cooling to room temperature, the patch solidifies and becomes fixed to the damaged portion. This thermal transfer repair method enables on-site repair without the need for complex equipment, and the melted patch not only physically fills the damaged area but also restores the shielding functionality. In fact, the radiation shielding material repaired by the thermal transfer process exhibited a shielding efficiency of 94.72% at 60 kV, which corresponds to approximately 98.91% of the shielding performance of the original, undamaged product—indicating excellent recovery performance.

### BRIEF DESCRIPTION OF DRAWINGS

FIG. 1 is a schematic diagram illustrating the manufacturing process of a thermoplastic polyurethane (TPU)/BiI₃ repair patch according to the present invention.

FIG. 2 illustrates (a) a schematic diagram of the TPU/BiI₃ repair patch and the repair process, (b) Fourier transform infrared (FT-IR) spectra of TPU 0, TPU 1, and the three raw materials used in TPU synthesis, and (c) a diagram showing the chemical structures of each material with functional groups corresponding to FT-IR peaks marked in the same colors.

FIG. 3 shows (a) X-ray photoelectron spectroscopy (XPS) survey spectra of TPU and TPU/BiI₃ samples, (b-d) high-resolution spectra of C is, O is, and N is for TPU and TPU/BiI₃, and (e, f) high-resolution spectra of Bi 4f and I 3d for TPU/BiI₃ samples.

FIG. 4 shows (a) thermogravimetric analysis (TGA) results and (b) derivative thermogravimetry (DTG) curves of TPU, TPU/BiI₃, PEG, and BiI₃ (with the DTG curve of the TPU/BiI₃ composite offset by +2 for peak comparison).

FIG. 5 illustrates (a) the actual image and schematic of the X-ray irradiation setup, (b) X-ray shielding efficiencies of TPU 0 through TPU 5, (c) linear attenuation coefficients and mass attenuation coefficients of TPU 0 through TPU 5, (d) real images of the repair process using thermal transfer (shield thickness: 1.12±0.026 mm), (e) comparison of X-ray shielding performance before damage, after damage, and after repair, (f) thermal adhesion of the TPU/BiI₃ composite patch to various substrates including polyethylene (PE), cotton fabric, polypropylene (PP), and glass, (g) image of a TPU/BiI₃ composite (10 cm×17 cm) cast directly into a mold and the sample after drying (prepared with the same composition as TPU 5 but with DMF increased from 2.5 mL to 12 mL), and (h) an image of a large-area flexible film that can be folded or rolled.

FIG. 6 shows the results of comparative peel tests between the TPU/BiI₃ patch and various substrates.

FIG. 7 shows (a, d) schematics of two types of repeated bending tests, (b, c) X-ray shielding performance and relative performance results from the wrap-around method, and (e, f) shielding performance and relative performance results from the fully-folded method.

FIG. 8 shows the long-term durability test results of the TPU/BiI₃ patch after 1,000 repeated folds.

FIG. 9 shows the bending test results for a new lead rubber shielding material.

FIG. 10 shows the tensile strength test results of undamaged and repaired lead rubber.

FIG. 11 shows the tensile test results of TPU/BiI₃ patch samples with varying BiI₃ concentrations.

### DETAILED DESCRIPTIONS

The embodiments of the present invention will now be described in detail with reference to the accompanying drawings. It should be understood that the present invention may be subject to various modifications and may take different forms. Therefore, the specific embodiments illustrated in the drawings and described in the specification are not intended to limit the invention to the particular forms disclosed. Rather, they are intended to cover all modifications, equivalents, and alternatives falling within the spirit and scope of the invention. In the drawings, like reference numerals are used to denote like elements.

The terminology used herein is for the purpose of describing particular embodiments only and is not intended to be limiting of the invention. As used herein, the singular forms include plural referents unless the context clearly dictates otherwise. It should also be understood that the terms “include” and “have,” and variations thereof, are intended to denote the presence of stated features, steps, operations, elements, components, or combinations thereof, but are not intended to exclude the presence or addition of one or more other features, steps, operations, elements, components, or combinations thereof.

Unless otherwise defined, all technical and scientific terms used herein have the same meaning as commonly understood by one of ordinary skill in the art to which this invention belongs. Terms that are generally defined in commonly used dictionaries should be interpreted as having a meaning that is consistent with their usage in the relevant technical field, and should not be interpreted in an idealized or overly formal sense unless expressly so defined herein.

### EXAMPLE

### Materials

The following reagents were used in the present invention: hexamethylene diisocyanate (HDI, Germany, purity≥98.0%), polyethylene glycol (PEG, Germany, average molecular weight 950-1050, for synthesis), 1,4-butanediol (BDO, Taiwan), and bismuth iodide (BiI₃, China, nanopowder), all purchased from Merck (Sigma-Aldrich) with a purity of 99% or higher.

Anhydrous dimethylformamide (DMF, Germany, purity 99.8%) was also purchased from Merck (Sigma-Aldrich) and used as a solvent during synthesis. Among these, HDI and DMF were used without any pretreatment, while BiI₃, PEG, and BDO were dried in a vacuum oven at 80° C. for one hour prior to use.

### Preparation of TPU/BiI₃ Composite

The TPU/BiI₃ composite was prepared using precisely optimized amounts of each component based on repeated experiments. The molar ratio of hard segment, soft segment, and chain extender was set at 1.2:1:0.2, ensuring a stoichiometric balance of [—NCO]:[—OH] at 1:1 for complete reaction and optimal polymer network formation.

If the [—NCO]:[—OH]ratio exceeds 2:1, the excess isocyanate tends to produce urea through side reactions, leading to a broader crosslinking distribution and degradation of material properties. Although a high urea content increases stiffness through intermolecular and intramolecular hydrogen bonding, it also induces brittleness and reduces processability.

Conversely, if the ratio is too low, insufficient crosslinking leads to more linear or branched structures, significantly lowering tensile strength, chemical resistance, and thermal stability. Therefore, maintaining a 1:1 molar ratio between diol and isocyanate is crucial for forming a well-balanced polyurethane network in terms of mechanical and chemical properties.

In this invention, an aliphatic isocyanate (HDI) was used instead of an aromatic one to prevent yellowing and degradation during X-ray exposure and to maintain stability under prolonged electromagnetic radiation.

As for the soft segment, polyethylene glycol (PEG), a polyether-based material, was selected over polyester-based materials due to its superior water resistance—an important factor considering exposure to sweat or disinfectants during extended wear of shielding garments.

1,4-Butanediol (BDO) was selected as the chain extender for forming ordered hard segments and promoting micro-phase separation, thereby enhancing mechanical properties. Its linear structure induces strong hydrogen bonding within the hard segment, improving tensile strength, elasticity, and durability. BDO also exhibits excellent hydrolytic stability and processability compared to other diols, making it suitable for forming a stable and flexible TPU matrix.

The volume and mass of HDI, PEG, and BDO were calculated based on their molecular weights, and their specific compositions are shown in Table 1.

TABLE 1

| Name | HDI | PEG | BDO | BiI₃ | DMF |
|---|---|---|---|---|---|
| TPU 0 | 771 [symbol] | 4.0 g | 70.89 [symbol] | 0.0 g | 2.5 mL |
| TPU 1 | | | | 0.5 g | |
| TPU 2 | | | | 1.0 g | |
| TPU 3 | | | | 1.5 g | |
| TPU 4 | | | | 2.0 g | |
| TPU 5 | | | | 2.5 g | |

To impart X-ray shielding functionality, the TPU was synthesized by gradually increasing the content of BiI₃. BiI₃ was incrementally added until the viscosity of the mixture became too high to allow effective stirring or mold casting. This approach was designed to incorporate the maximum possible amount of BiI₃ while maintaining practical processability.

DMF (dimethylformamide) was used as the solvent, and its volume was fixed based on experimental determination as the minimum amount required to dissolve up to 2.5 g of BiI₃.

Prior to synthesis, all materials were preheated in an oven at 80° C. According to the ratios specified in Table 1, BiI₃ was added to DMF and mixed in a vial, followed by sonication to completely dissolve the BiI₃ and produce a homogeneous BiI₃/DMF solution.

Once PEG was fully liquefied in the vial, all components were mixed on an 80° C. hot plate inside a nitrogen (N₂) glove box. The BiI₃/DMF solution (or DMF alone for TPU 0) and BDO were added to the liquefied PEG, followed by dropwise addition of HDI.

The stirring speed of the magnetic stirrer was set to 300 rpm. As the urethane reaction proceeded, the viscosity of the TPU gradually increased. Once the viscosity became too high for continued stirring, the reaction was halted, and the mixture was poured into a 20×20 mm plastic mold.

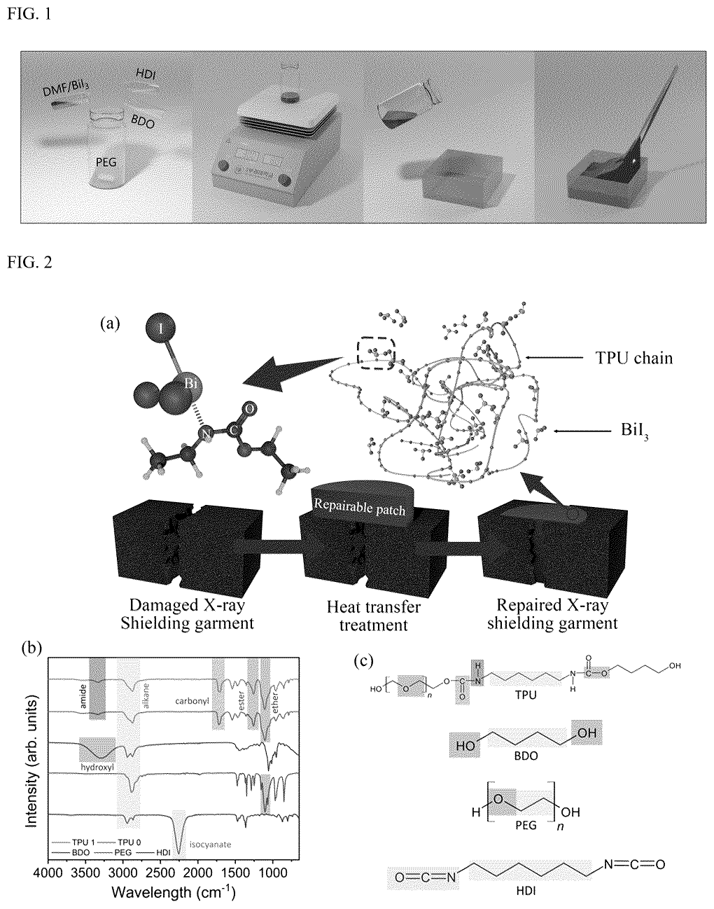

To remove internal bubbles and allow the reaction to complete, the mold was heat-treated in a vacuum oven at 80° C. for 18 hours. The mold was then carefully removed, and the final TPU composite was obtained. The entire process is schematically illustrated in FIG. 1.

### Thermal Transfer Process for Repairing Damaged Products

To evaluate the performance of the repair patch, a commercial lead rubber shielding material was intentionally cut to simulate damage. The damaged area was elliptical, with a major axis of 12 mm and a minor axis of 4 mm.

The fabricated repair patch was placed over the damaged area, then covered with a polytetrafluoroethylene (PTFE) sheet, commonly known as a Teflon sheet. A standard household iron was used to gently press and rub the patch. The iron was set to “Cotton” mode, corresponding to a surface temperature of approximately 200° C.

As heat was transferred to the patch, the patch partially melted and filled the damaged region of the lead rubber. After a few minutes of cooling at room temperature, the repaired lead rubber was easily separated from the Teflon sheet.

### Characterization

FT-IR analysis was performed using a Fourier Transform Infrared (FT-IR) spectrometer. The instrument used was a JASCO FT-4100 (Japan). Measurements were conducted over a wavenumber range of 4000 to 650 cm⁻¹.

X-ray photoelectron spectroscopy (XPS) analysis was performed using the AXIS SUPRA system by KRATOS Analytical Ltd. (UK). The measurement conditions were set using an anodized aluminum standard (Anodized library Al), with an emission current of 15.00 mA and an X-ray power of 255.00 W. The analysis was conducted on TPU 0 and TPU 5 samples, and both survey spectra and narrow spectra for N is, C is, O is, Bi 4f, and I 3d were collected.

Peak fitting was performed using the XPSPEAK4.1 software with the Shirley background model applied. For peaks corresponding to the same chemical environment, the full width at half maximum (FWHM) was set to the same value to improve fitting accuracy.

Additionally, the p, d, and f orbitals were treated as doublet peaks with area ratios of 1:2, 2:3, and 3:4, respectively. These constraints were applied to enable precise peak deconvolution.

Thermogravimetric analysis (TGA) was conducted using TA Instruments equipment, including the Discovery DSC 25, Discovery TGA 55, and TMA Q400 (USA). The tests were performed under a nitrogen (N₂) atmosphere with a heating rate of 10° C./min and a maximum temperature of 900° C.

The X-ray shielding performance of the TPU/BiI₃ composite and the repaired shielding material was evaluated using an X-ray irradiator (X-rad iR-160 irradiator, PERCISION, USA) and an X-ray detector.

During measurement, the distance between the X-ray source and the sensor was set to 800 mm. A 4T lead plate with a 15 mm diameter hole was placed 170 mm from the sensor, and test specimens were placed over the hole to measure X-ray transmission.

The experimental conditions were as follows: 60 or 100 kV tube voltage, 4 mA current, 5 seconds of irradiation, and a 10-second cooling period between measurements. To ensure accuracy, each sample was tested five times and the results were averaged.

The X-ray shielding efficiency was calculated using Equation (1) below:

$$S = \{ 1 - ( {II}_{0}^{- 1} ) \} \times 100 ( \% ) \qquad Equation ( 1 )$$

Here, I and Iₒ represent the detected X-ray intensities with and without the sample, respectively, and S denotes the shielding efficiency.

Meanwhile, the linear attenuation coefficient (μ) represents the probability per unit length that a photon will interact with the material and be attenuated. It serves as a physical measure of how rapidly X-rays are attenuated as they pass through a material.

To eliminate the influence of thickness and allow for a direct comparison of intrinsic shielding performance, the linear attenuation coefficient was calculated using Equation (2) below:

$$I = {I}_{O} exp ( - μ t ) \qquad Equation ( 2 )$$

In Equation (2), μ is the linear attenuation coefficient (cm⁻¹), t is the sample thickness (cm), I is the transmitted X-ray intensity through the sample, and Iₒ is the incident X-ray intensity. Additionally, the mass attenuation coefficient (μₘ) can be calculated by dividing the linear attenuation coefficient by the density of the material. This coefficient represents the probability of photon interaction per unit mass and serves as an intrinsic measure of a material's shielding performance, independent of its density. The unit of the mass attenuation coefficient is cm²/g.

Durability testing under repeated bending was conducted manually and consisted of two test methods reflecting typical usage conditions.

The first method, the wrap-around test, simulated mild usage conditions by wrapping the sample around a cylindrical mandrel with a diameter of 11.43 mm and repeating the bending motion.

The second method, the fully-fold test, simulated harsher conditions by forcibly folding and pressing the sample to induce bending.

Each test was repeated 100 times, and the X-ray shielding efficiency after bending was measured using the same calculation method described previously.

In addition, relative performance was calculated by dividing the shielding efficiency after folding by the initial shielding efficiency of the repaired shielding material.

A tensile test was also conducted using a universal testing machine (UTM) equipped with a 100 kgf load cell (Tinius Olsen H1KT, Horsham, PA, USA) at a crosshead speed of 5 mm/min.

Finally, scanning electron microscopy (SEM) and energy-dispersive X-ray spectroscopy (EDS) mapping analyses were performed using a field emission SEM (JEOL JSM-IT800SHL, Japan).

### Results and Discussion

FIG. 2 illustrates the schematic diagram and chemical structure of the repairable TPU/BiI₃ patch.

As shown in FIG. 2(a), BiI₃ is introduced into the TPU precursor in a DMF-dissolved state during the synthesis process. At this stage, Bi³⁺ and I⁻ ions derived from BiI₃ are incorporated into the TPU matrix. In particular, coordination bonds formed between Bi³⁺ ions and nitrogen (N) atoms within the urethane linkages help prevent aggregation of BiI₃ and enable its uniform dispersion throughout the TPU. This mechanism is discussed in further detail in the XPS analysis section.

The fabricated repair patch is directly applied to the damaged area of the shielding garment and adhered by filling the damaged gap through a thermal transfer method. As a result, the thermoplastic composite patch can effectively repair the damaged area and is expected to significantly extend the service life of the radiation shielding garment.

Meanwhile, to verify the chemical structure of the TPU/BiI₃ composite, FT-IR analysis was performed on hexamethylene diisocyanate (HDI), polyethylene glycol (PEG), 1,4-butanediol (BDO), TPU 0 (pure TPU), and TPU 1 (containing 0.5 g of BiI₃) using a Fourier-transform infrared spectrometer (FT-IR).

As shown in FIGS. 2(b) and 2(c), the FT-IR results revealed asymmetric and symmetric stretching vibrations of C—H bonds from linear carbon chains in the range of 3000-2800 cm⁻¹. For HDI, a strong peak was observed around 2250 cm⁻¹, corresponding to the isocyanate (—NCO) functional group. This peak was not present in any of the TPU samples, indicating that all —NCO groups were completely consumed through the urethane-forming reaction.

In general, an excess of isocyanate can lead to the formation of allophanate groups through initial urethane bonding and subsequent crosslinking reactions. Allophanate is typically characterized by two sets of triplet peaks near 1220, 1280, 1310 cm⁻¹ and 3298, 3267, 3233 cm⁻¹.

However, none of the TPU samples synthesized in this study exhibited such peaks, suggesting that no additional crosslinking reactions occurred that could impair the material's flexibility.

Meanwhile, in the FT-IR spectrum of BDO (1,4-butanediol), a broad and strong absorption peak was observed in the range of 3590-3000 cm⁻¹, indicating the presence of hydroxyl (—OH) groups.

In both TPU and TPU/BiI₃ samples, this —OH peak appeared with reduced intensity, which can be interpreted as the hydroxyl groups being consumed during the formation of urethane linkages and reacting with other components, thus lowering the relative content of residual —OH groups.

Instead, broad and weak peaks were observed near 3332 cm⁻¹ and 3325 cm⁻¹ in TPU and TPU/BiI₃, respectively, corresponding to N—H groups within the urethane linkage.

Additionally, peaks observed only in the TPU and TPU/BiI₃ samples in the regions of 1750-1600 cm⁻¹ and 1300-1200 cm⁻¹ were assigned to carbonyl (C═O) and ester (O═C—O) groups, both of which are characteristic components of urethane linkages.

A common ether peak near 1095 cm⁻¹ was detected in TPU, TPU/BiI₃, and PEG. This is because PEG serves as the soft segment in TPU, where only the hydroxyl groups (—OH) of PEG participate in the reaction, while the C—O—C structure remains intact after the reaction. Thus, both TPU and PEG exhibit the same ether peak.

Taken together, the FT-IR analysis results shown in FIGS. 2(b) and 2(c) confirm that TPU was successfully synthesized using HDI, PEG, and BDO, and that the addition of BiI₃ during synthesis did not interfere with the formation of urethane linkages.

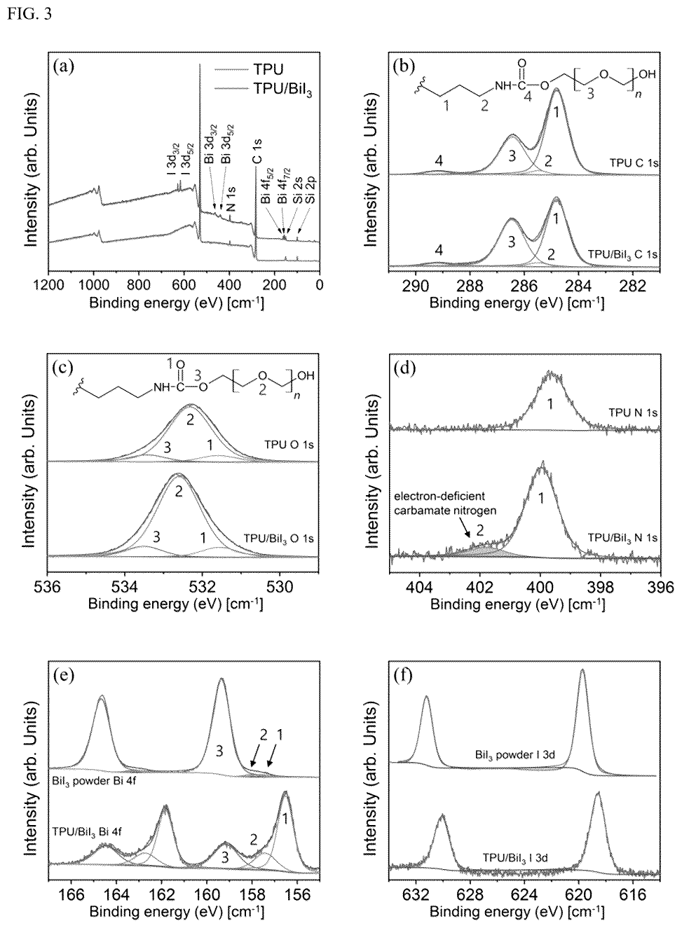

FIG. 3(a) presents the survey spectra of TPU and TPU/BiI₃.

As shown in the figure, both samples exhibited peaks corresponding to carbon (C), oxygen (O), and nitrogen (N). A silicon (Si) peak was also partially observed, although Si is not part of the original composition of either TPU or TPU/BiI₃. This peak is presumed to result from impurities introduced during the synthesis process or from Si contamination originating from the carbon tape used in the XPS analysis.

Meanwhile, since BiI₃ was incorporated during the synthesis of the TPU/BiI₃ composite, peaks corresponding to bismuth (Bi) and iodine (I) appeared only in the TPU/BiI₃ sample.

As shown in FIG. 3(b), the C is narrow spectra of TPU and TPU/BiI₃ exhibited very similar patterns. Four distinct carbon states were observed, each forming a peak at different binding energy positions.

Specifically, Peak 1 (approximately 284.8 eV) corresponds to linear carbon chains. This type of carbon has a higher electron density (more negative charge) compared to other states, which results in a higher kinetic energy of the emitted photoelectrons from the core level, thereby appearing at the lowest binding energy on the spectrum.

Following the same principle, Peak 2 (285.5 eV) corresponds to carbon bonded with nitrogen in urethane linkages (C—N). Peaks 3 (286.4 eV) and 4 (289.2 eV) correspond to carbon bonded to one and two oxygen atoms, respectively. Among them, Peak 4 appears at the highest binding energy due to the strongest electron-withdrawing effect, followed by Peak 3.

No significant shifts in peak positions or formation of new peaks were observed in the C is spectra, suggesting that BiI₃ did not interfere with urethane bond formation and had minimal impact on the carbon environment in TPU.

As shown in FIG. 3(c), the oxygen (O) spectrum was deconvoluted into three peaks. Similar to carbon, the oxygen spectra of TPU and TPU/BiI₃ showed only slight differences.

Peak 1, located at 531.6 eV, corresponds to oxygen atoms doubly bonded to carbon (O═C) in urethane linkages.

The largest peak—appearing at 532.3 eV in TPU and 532.6 eV in TPU/BiI₃—is attributed to oxygen atoms present in the PEG chains.

Peak 3 appears due to oxygen atoms situated between urethane bonds and PEG chains. The carbon atoms bonded to this type of oxygen are also engaged in double bonds with other oxygen atoms. As a result, the oxygen atoms responsible for Peak 3 are less effective at attracting electrons compared to the others, leading to their appearance at the highest binding energy: 533.4 eV for TPU and 533.5 eV for TPU/BiI₃.

In contrast, as shown in FIG. 3(d), the nitrogen (N) spectra exhibit a distinct difference between TPU and TPU/BiI₃. In TPU, a single peak appears at 399.6 eV, corresponding to nitrogen in urethane linkages. However, in TPU/BiI₃, in addition to the peak at 400.0 eV, an extra peak emerges at approximately 401.8 eV, which is attributed to carbamate nitrogen with lower electron density.

As previously discussed, a peak at a higher binding energy indicates a lower electron density, suggesting that nitrogen's electron density was reduced due to electron donation—most likely via coordination bonding with Bi³⁺.

FIGS. 3(e) and 3(f) present a comparison of the spectra between BiI₃ powder and the TPU/BiI₃ composite to more clearly verify the interaction between TPU and BiI₃.

For the bismuth (Bi) spectra, the spin-orbit splitting (SOS) value of the Bi 4f orbital was set to 5.31 eV, and the area ratio of the Bi 4f_{5/2} to 4f_{7/2} peaks was fixed at 3:4. Based on these constraints, the peak deconvolution was carried out.

In the TPU/BiI₃ spectrum, the Bi-metal peak (Peak 1) was observed at 156.5 eV, and the Bi³⁺ peak (Peak 3) appeared at 159.1 eV. Notably, an additional peak (Peak 2) at a binding energy of 157.4 eV was also detected. This intermediate peak is interpreted as representing Bi in an oxidation state between 0 and +3.

In contrast, in the BiI₃ powder, the Bi³⁺ peak (Peak 3) was mainly observed at 159.5 eV, with only a negligible shoulder peak. As a post-transition metal, Bi can exist in multiple oxidation states (e.g., Bi³⁺, Bi⁵⁺) and features an expanded octet structure.

Furthermore, Bi can act as an electron donor and form additional coordination bonds. Therefore, the newly observed peak at a lower binding energy than the Bi³⁺ peak suggests that Bi exists in a state with higher electron density than typical Bi³⁺. This increase in electron density is attributed to the additional electron donation from nitrogen (N) atoms in the TPU matrix.

As shown in FIG. 3(f), the I 3d spectra of TPU/BiI₃ and BiI₃ powder were analyzed by applying a spin-orbit splitting (SOS) value of 11.52 eV, with the area ratio of the 3d_{3/2} and 3d_{5/2} peaks constrained to 2:3. Both the BiI₃ powder and the TPU/BiI₃ composite exhibited doublet peaks corresponding to a single oxidation state. In the BiI₃ powder, the I 3d peak was observed at 619.7 eV, whereas in the TPU/BiI₃ composite, it appeared at a slightly lower binding energy of 618.6 eV, indicating an increase in electron density.

Since iodine (I) is primarily bonded to bismuth (Bi), the electron transfer from nitrogen (N) to Bi may have indirectly increased the electron density around iodine. A similar phenomenon is often observed in XPS carbon spectra, where secondary carbon atoms bonded to carbonyl groups exhibit a shift of approximately 0.7 eV due to the electron-withdrawing effect of oxygen, despite forming only C—C bonds.

From the analyses presented in FIG. 3, two key conclusions can be drawn. First, chemical interaction occurred between Bi and N. Second, even when BiI₃ was introduced during in-situ synthesis, the urethane bonds were still effectively formed. The coordination interaction between Bi and N within the urethane matrix contributed to the homogeneous dispersion of BiI₃ within the TPU matrix. This interaction suppressed the agglomeration of BiI₃ and allowed uniform distribution throughout the composite.

In X-ray shielding composites, the dispersibility of the shielding material is a critical factor, as better dispersion enables more efficient X-ray attenuation even with a smaller amount of filler. To further understand the thermal decomposition mechanism and thermal stability of TPU and TPU/BiI₃, thermal analyses were conducted for TPU, BiI₃, and PEG. The temperature corresponding to the maximum rate of decomposition was determined based on the peak position in the derivative thermogravimetric (DTG) curves obtained from TGA analysis.

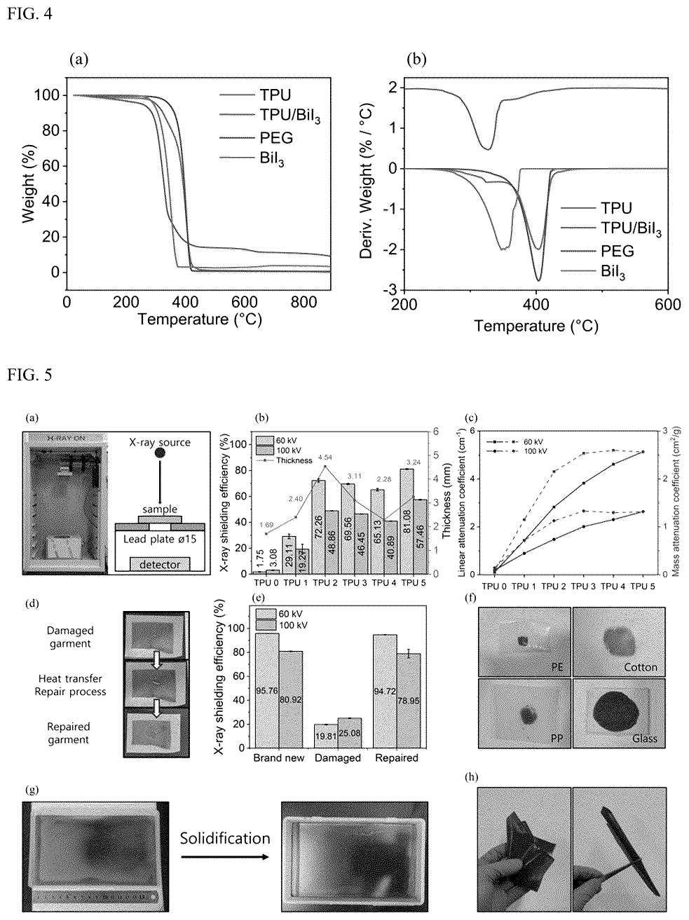

FIG. 4 presents the TGA and DTG curves of the four previously mentioned materials: TPU, TPU/BiI₃, BiI₃, and PEG. According to the data, PEG exhibited the fastest decomposition at 403.7° C., while BiI₃ decomposed at 352.4° C. For neat TPU, an initial weight loss was observed at 324.5° C., followed by a major drop at 403.8° C. The weight loss at 324.5° C. corresponds to the thermal degradation of urethane linkages, and the sharp decline at 403.8° C. is attributed to the decomposition of the PEG chains that constitute the soft segments of the TPU. The decomposition temperature of PEG at 403.7° C. is also confirmed by its DTG curve.

In the case of TPU/BiI₃, a three-step thermal degradation process was observed. First, similar to TPU, urethane bond degradation occurred at 326.8° C. Second, due to the dispersion of BiI₃ within the polymer matrix, a shoulder peak appeared near 352.4° C., which corresponds to the decomposition of BiI₃. Finally, the decomposition of the internal PEG chains took place at approximately 402° C.

The onset of thermal decomposition is defined as the temperature at which a 5% weight loss occurs, commonly referred to as T₅%.

According to the TGA curve shown in FIG. 4(a), the T₅% of neat TPU was 301.6° C., whereas that of TPU/BiI₃ was slightly lower at 254.4° C. This reduction in thermal stability can be attributed to the well-dispersed BiI₃ within the TPU matrix, which likely acted as a heat-transfer medium, facilitating the transfer of external thermal energy into the polymer and thereby initiating earlier degradation. Although the incorporation of BiI₃ slightly lowered the thermal stability, a decomposition onset temperature of 254° C. remains sufficiently high for practical applications, such as medical protective garments. The key thermal properties extracted from the analysis are summarized in Table 2.

TABLE 2
Key thermal degradation parameters
obtained from TGA and DTG analysis.

| Unit: ° C. | TPU | TPU/BiI3 | PEG | BiI3 |
|---|---|---|---|---|
| T₅ % | 301.6 | 354.4 | 344.6 | 293.0 |
| DTGₚₑₐₖ | 324.6, 403.8 | 326.8 | 403.7 | 352.4 |

The X-ray shielding performance of each sample was evaluated using the X-ray measurement system illustrated in FIG. 5(a). The shielding efficiency of TPU 0-5 samples is shown in FIG. 5(b), measured under X-ray tube voltage conditions of 60 kV and 100 kV. All measurements were performed five times, and the average value was reported as the result. Error bars indicate the standard deviation.

As shown in FIG. 5(b), TPU 0 (thickness: 1.69 mm), which contained no BiI₃, exhibited only 1.75% shielding efficiency under the 60 kV condition. However, as the BiI₃ content gradually increased, the shielding performance also improved. For the TPU sample with a thickness of 3.24 mm, shielding efficiencies of 81.08% at 60 kV and 57.46% at 100 kV were observed.

In some cases, however, higher shielding efficiency was observed even at lower BiI₃ content due to differences in sample thickness. This was observed for TPU 2 (thickness: 4.54 mm) and TPU 3 (thickness: 3.11 mm). To eliminate the influence of thickness, the linear attenuation coefficient was introduced and calculated.

In addition, the mass attenuation coefficient was also calculated, representing the degree of X-ray energy attenuation per unit length (cm⁻¹) and per unit mass (cm²/g), respectively. A higher value indicates greater X-ray attenuation. The relevant results are shown in FIG. 5(c).

As shown in FIG. 5(c), the linear attenuation coefficient increased from 0.104 cm⁻¹ to 5.13 cm⁻¹ with increasing BiI₃ content in the TPU matrix. Similarly, values such as the mean free path, half-value thickness, and tenth-value thickness of each sample followed the same trend.

These results experimentally demonstrate that increasing the BiI₃ content during TPU synthesis is effective in enhancing X-ray shielding performance. Furthermore, the TPU/BiI₃ composite developed in this study exhibited the highest X-ray shielding efficiency among previously reported organic/inorganic composites.

As shown in FIG. 5(d), to evaluate the repairability and shielding efficiency of the repaired shielding garment, an elliptical hole was intentionally created in a commercial lead rubber shield to simulate damage. A TPU/BiI₃ composite patch was placed over the damaged area and partially melted by heating, allowing the repair patch to fill the hole through a simple thermal transfer process.

FIG. 5(e) shows the change in shielding performance before damage, after damage, and after repair of the lead rubber shielding material. According to FIG. 5(e), the new lead rubber shield (thickness: 1.12 mm) exhibited 95.76% X-ray shielding efficiency under 60 kV conditions. However, due to the artificial damage via the elliptical hole, shielding efficiency decreased by 19.81%. After the repair process, the repaired lead rubber displayed a shielding efficiency of 94.72% at 60 kV, which corresponds to 98.91% of the performance prior to damage.

As a result, the shielding material was successfully repaired using the thermal transfer process with the repair patch, and its performance was restored to nearly the same level as before damage.

FIG. 5(f) demonstrates that the TPU/BiI₃ patch exhibits excellent thermal adhesion not only to glass, cotton fabric, and lead rubber, but also to certain polymer materials such as polypropylene (PP) and polystyrene (PS). This adhesion characteristic suggests the potential of the TPU/BiI₃ patch to be applied to various substrates commonly used in industrial settings and daily life.

This adhesive mechanism is presumed to result from a combination of physical interfacial adhesion and intermolecular interactions that vary depending on the nature of the substrate material.

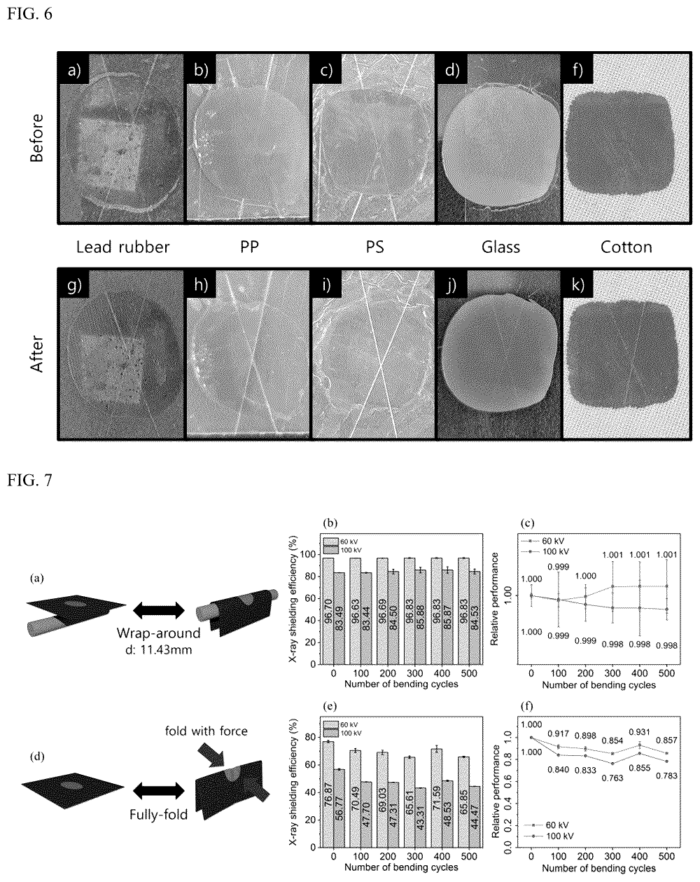

To further evaluate the adhesive strength across different substrates, a comparative peel test was conducted, and the results are shown in FIG. 6.

As illustrated in FIG. 6, the adhesion observed across various materials indicates that the developed patch holds high potential for use in diverse shielding environments. This stands in contrast to previously developed hydrogel-based self-healing shielding materials, which often suffer from poor interfacial adhesion due to their high water content.

In addition, by adjusting the concentration of the precursor solution, a large-area flexible patch (10 cm×17 cm) was successfully fabricated, as shown in FIG. 5(g). According to the invention, by maintaining the same TPU precursor and BiI₃ mixing ratio while increasing the amount of organic solvent (DMF) from 2.5 mL to 12 mL, the patch could be manufactured into a thin film with a thickness of approximately 0.14 mm.

Referring to FIG. 5(g), the produced thin film exhibited sufficient mechanical integrity, showing excellent flexibility that allowed it to be folded or rolled without tearing. This result demonstrates that the repair patch can also be fabricated in the form of a thin, flexible film, significantly broadening its application potential compared to conventional approaches.

These results suggest that the developed repair patch has potential applications that extend beyond basic X-ray shielding, showing promise for widespread use in various industrial and practical settings.

Additionally, the water resistance of the TPU/BiI₃ patch (thickness: 1.74 mm) was evaluated under much harsher conditions than typical usage scenarios. While radiation protective garments are generally exposed only to short-term moisture, such as sweat or surface cleaning, in this study, the sample was fully immersed in distilled water at room temperature for extended durations.

X-ray shielding efficiency was measured at 60 kV and 100 kV in 24-hour intervals, up to a maximum of 144 hours. Although the shielding performance showed a gradual decline over time, the patch retained over 60% of its initial efficiency after 72 hours of immersion, and more than 54% even after 120 hours. Notably, the rate of performance degradation slowed after 96 hours, suggesting that the material had reached a relatively stable condition under continuous water exposure.

To evaluate the durability of the repaired shielding garment (thickness: 1.38 mm), two types of bending tests were conducted. FIGS. 7(a) and 7(d) show the procedures of the two tests, while FIGS. 7(b) and 7(e) present the X-ray shielding performance results.

As shown in FIG. 7(c), the wrap-around test demonstrated stable X-ray shielding efficiency without any noticeable decrease in performance. As previously noted, the error bars represent the standard deviation, and any changes observed within the third decimal place are smaller than the typical measurement error for shielding performance, indicating the high reliability of the result.

As shown in FIGS. 7(e) and 7(f), since no significant degradation in shielding performance was observed during the wrap-around test, a more rigorous “fully-fold” test was conducted to simulate improper use or storage conditions. In this test, deep creases were intentionally created on the TPU/BiI₃ patch, resulting in a slight reduction in X-ray shielding performance. The relative shielding efficiency, compared to the initial performance, was measured to be 85.70% at 60 kV and 78.30% at 100 kV.

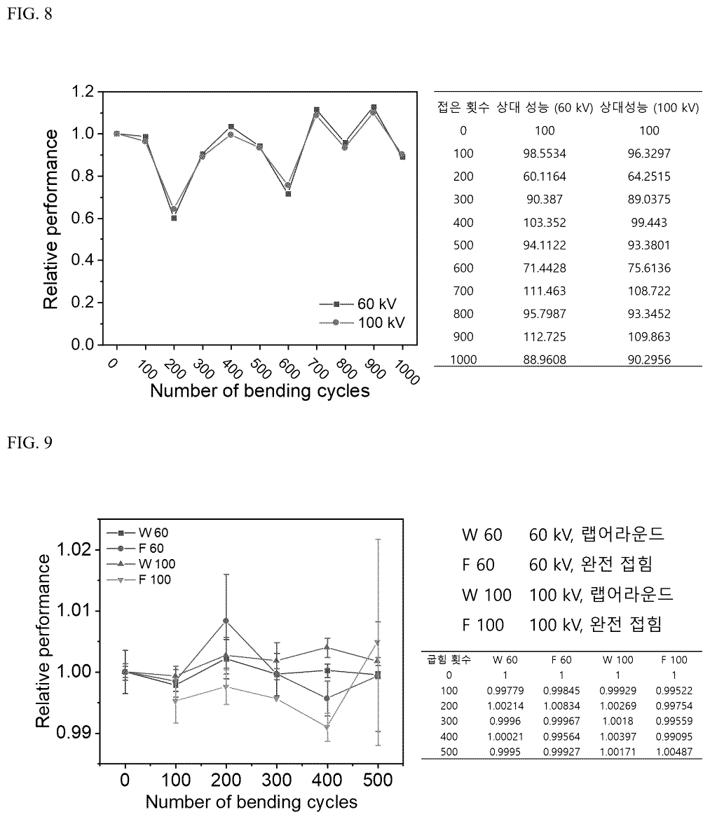

FIG. 8 presents the results of a long-term bending durability test simulating 1000 cycles. As shown, although a minor performance drop was observed due to repeated folding, there were no critical physical damages such as tearing or delamination from the substrate. This confirms that the TPU/BiI₃ patch can maintain stable shielding efficiency even under prolonged and repetitive mechanical stress during practical use.

Moreover, in cases of improper storage leading to complete folding of the shielding garment, the damaged areas remained visually detectable, and no severe structural issues, such as material separation, were observed.

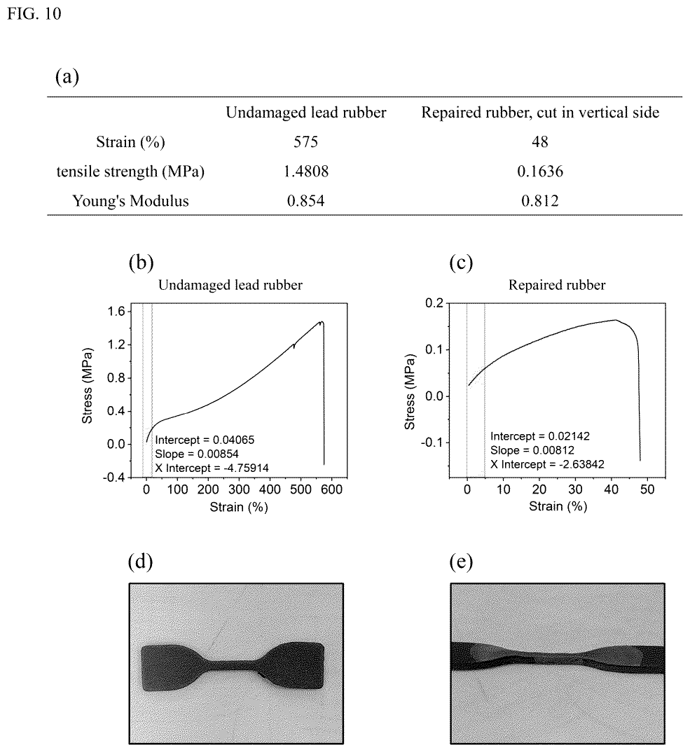

FIG. 9 shows the bending test results for a new lead-rubber shielding sheet, and FIG. 10 presents the tensile strength comparison between the undamaged and repaired lead-rubber samples. These results demonstrate that the repaired shielding material retains mechanical properties comparable to the original.

Referring to FIGS. 9 and 10, although the tensile strength of the repaired lead-rubber is lower than that of the undamaged one, its overall mechanical properties remain sufficient for practical applications. Notably, the Young's modulus values are maintained at similar levels, suggesting that the material's elastic behavior is well preserved despite the reduction in tensile strength.

Specifically, FIG. 10(a) shows the mechanical properties calculated through UTM (Universal Testing Machine) for both the undamaged and repaired lead-rubber samples. The Young's modulus remained similar before and after repair, but significant differences were observed in the maximum tensile strength and strain. The undamaged rubber exhibited a high strain of 575% and a tensile strength of 1.4808 MPa, whereas the repaired rubber showed a much lower strain of 48% and tensile strength of 0.1636 MPa. FIGS. 10(b) and 10(c) display the stress-strain curves of the undamaged and repaired samples, respectively. The repaired sample showed a rapid increase in stress followed by sudden fracture, indicating more brittle behavior.

FIGS. 10(d) and 10(e) show the actual specimens used in the tensile tests.

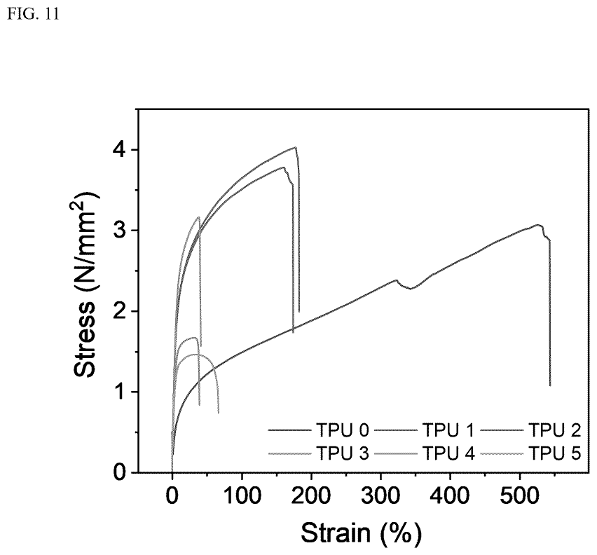

Additionally, to evaluate the mechanical properties of the TPU/BiI₃ composites, tensile tests were conducted on samples (TPU 0-5) with varying BiI₃ concentrations. The results are summarized in Table 3 and illustrated in FIG. 11.

TABLE 3

| Sample | TPU 0 | TPU 1 | TPU 2 | TPU 3 | TPU4 | TPU 5 |
|---|---|---|---|---|---|---|
| Tensile stress | 3.060 | 4.022 | 3.775 | 3.158 | 1.664 | 1.457 |
| (N/mm²) | | | | | | |
| Strain (%) | 545.16 | 183.26 | 174.76 | 41.60 | 37.53 | 66.98 |

According to Table 3 and FIG. 11, the initial addition of BiI₃ (TPU 1) increased the tensile strength, but further increases in BiI₃ content resulted in a sharp decline in both tensile strength and elongation at break. This indicates that while a moderate amount of BiI₃ can enhance the mechanical strength of the composite, excessive addition adversely affects its ductility and tensile properties.

### CONCLUSION

In this study, a repairable TPU/BiI₃ patch was successfully developed for restoring damaged X-ray shielding materials using a simple thermal transfer process. Regardless of the shape of the damaged area, the TPU/BiI₃ patch effectively filled the gap during the heat transfer process and restored over 97% of the original shielding performance.

Moreover, the patch maintained stable performance at temperatures below 300° C. During synthesis, BiI₃ was uniformly dispersed in the TPU matrix due to a chemical interaction between bismuth (Bi) and nitrogen (N) within the urethane bonds.

Even after repair, the shielding material demonstrated good durability when bent or folded, without delamination from the original structure. Furthermore, the repair patch was successfully tested on various substrates such as PE, PP, glass, and cotton fabric under the same conditions as lead-rubber, showing strong adhesion.

These findings suggest that the TPU/BiI₃ patch developed in this work has potential applications beyond conventional radiation shielding environments, offering broad applicability and compatibility with diverse materials.

While the preferred embodiments of the present invention have been described above, it will be understood by those skilled in the art that various modifications and changes can be made without departing from the spirit and scope of the invention as defined in the following claims.

What is claimed is:

1. A method for repairing a damaged portion of a radiation shielding material comprising:
placing a polyurethane patch containing a bismuth halide compound on the damaged portion of the radiation shielding material; and
melting the patch by applying heat,
wherein the polyurethane patch containing the bismuth halide compound is used to repair the radiation shielding material.

2. The method of claim 1, wherein the radiation shielding material comprises lead rubber.

3. The method of claim 1, wherein the polyurethane patch is prepared by mixing a bismuth halide compound, a polyurethane precursor, and an organic solvent.

4. The method of claim 3, wherein the bismuth halide compound comprises bismuth iodide (BiI₃), and the polyurethane precursor comprises hexamethylene diisocyanate (HDI), polyethylene glycol (PEG), and 1,4-butanediol (BDO).

5. The method of claim 4, wherein the bismuth iodide (BiI₃) is dispersed within the polyurethane by forming coordination bonds between bismuth ions and nitrogen atoms in the polyurethane.

6. The method of claim 3, wherein the organic solvent comprises dimethylformamide (DMF), and a thin film-type polyurethane patch is formed by increasing the amount of DMF.

7. The method of claim 1, wherein the melting comprises melting the polyurethane patch by applying heat of 200° C. or higher, and the molten polyurethane patch flows into the damaged portion of the radiation shielding material to repair it.

8. The method of claim 7, wherein the radiation shielding material repaired with the polyurethane patch exhibits a shielding rate of 90% or more at a tube voltage of 60 kV.
